(19) United States
(12) Patent Application Publication
(10) Pub. No.: US 2003/0063465 A1
(43) Pub. Date: Apr. 3, 2003

(54) Etched metal light reflector for vehicle feature illumination

(76) Inventors: Richard K. McMillan, Dearborn, MI (US); Cindy M. Rutyna, Plymouth, MI (US); Walter K. Stepanenko, St. Clair Shores, MI (US); Lawrence L. Kneisel, Novi, MI (US)

Correspondence Address: BRINKS HOFER GILSON & LIONE, P.O. BOX 10395, CHICAGO, IL, 60611, US

(21) Appl. No.: 09/966,495

(22) Filed: Sep. 28, 2001

(51) Int. Cl. F21V 7/00

(52) U.S. Cl. 362/296; 362/341; 362/343; 216/100

(57) ABSTRACT

A method for constructing an illuminating and reflecting apparatus is provided. The method comprises the steps of providing a layered metal substrate with an aluminum layer between a first and a second layer of copper and removing a defined area of one of the layers of copper to form a reflective portion. A localized light source is positioned to allow light to reflect off of the reflective portion.

### FIELD OF THE INVENTION

The invention relates generally to the field of etched tri-metal circuits. Specifically, the invention relates to the use of an etched tri-metal circuit as a light reflector. This application is related to co-pending application entitled “Integrated Light and Accessory Assembly,” U.S. Patent Application No. ______, assigned to the same assignee as the present invention and filed the same day as the present invention. The entire contents of the co-pending application are hereby incorporated by reference.

### DESCRIPTION OF THE RELATED ART

Many designs for illumination on automobiles utilize light emitting diodes (LEDs) as light sources. LEDs have many advantages over traditional filament bulbs. LEDs produce less heat and use less energy than bulbs to provide the same amount of illumination.

Traditional lamp assemblies utilizing LEDs are commonly formed from stamped metal frets. The frets provide support and electrical conductivity for the LEDs. One disadvantage to these stamped metal frets is that the frets are not very flexible, and cannot be shaped to the varying contours and bends of a vehicle lamp assembly. Another disadvantage is that the metal frets are not cost-effective, since to form them to the contours of the vehicle, they must be specially molded in advance. In addition, since the metal frets are conductive, a non-conductive separation must remain between two frets to prevent short circuits during manufacturing and operation of the assembly.

### BRIEF SUMMARY OF THE INVENTION

In one embodiment of the present invention, a method for constructing an illuminating and reflecting apparatus is provided. The method comprises the steps of providing a layered metal substrate with an aluminum layer between a first and a second layer of copper and removing a defined area of one of the layers of copper to form a reflective portion. A localized light source is positioned to allow light to reflect off of the reflective portion.

In a second embodiment of the present invention, a method for forming a reflective aperture in a circuit board for providing illumination in automotive applications is provided. The method comprises the steps of providing a layered metal substrate, removing at least a top layer of the metal substrate to form a reflective area, and positioning a localized light source to allow light to reflect off of the reflective area.

In a third embodiment of the present invention, a method for forming a reflective aperture in a circuit board for providing illumination in automotive applications is provided. The method comprises the steps of providing a layered metal substrate, applying a layer of masking material on a surface of the layered metal substrate, exposing the layered metal substrate to an etching process, and removing the masking material from the layered metal substrate. A localized light source is positioned to allow light to reflect off of the reflective area.

In a fourth embodiment of the present invention, a reflective circuit board is provided. A substrate comprised of a layer of aluminum positioned between two layers of copper as at least one are of exposed aluminum and a localized light source is positioned to provide illumination of the exposed aluminum.

### BRIEF DESCRIPTION OF SEVERAL VIEWS OF THE DRAWINGS

FIG. 1 is a cross-sectional view of an etched tri-metal substrate formed by the method of the present invention and having a planar reflecting surface;

FIG. 2 is a cross-sectional view of an etched tri-metal substrate formed by the method of the present invention having multiple planar reflecting surfaces;

FIG. 3 is a cross-sectional view of an etched tri-metal substrate formed by the method of the present invention and having a non-planar reflecting surface;

FIG. 4 is a cross-sectional view of an etched tri-metal substrate formed by the method of the present invention and having both planar and non-planar reflecting surfaces;

FIG. 5 is a cross-sectional view of an etched tri-metal substrate formed by the method of the present invention and having a non-planar reflecting surface and a through hole;

FIG. 6 is a cross-sectional view of an etched tri-metal substrate formed by the method of the present invention and having both planar and non-planar reflecting surfaces and a through hole;

FIG. 7 is a cross sectional view of the etched tri-metal substrate of FIG. 5 utilizing a transparent substrate and a light emitting diode;

FIG. 8 is a cross sectional view of the etched tri-metal substrate of FIG. 6 utilizing a lens and a light emitting diode;

FIG. 9 is a cross sectional view of the etched tri-metal substrate of FIG. 1 utilizing a transparent substrate;

FIG. 10 is a cross sectional view of the etched tri-metal substrate of FIG. 2 utilizing a transparent substrate; and

FIG. 11 is a cross sectional view of a contoured etched tri-metal substrate formed by the method of the present invention and having planar reflective surfaces.

### DETAILED DESCRIPTION OF THE PREFERRED EMBODIMENTS OF THE INVENTION

Etched tri-metal (ETM) is commonly used in many electronic circuits. Aluminum forms an integral part of an ETM circuit, and features layers of copper sandwiched around the layer of aluminum. The copper acts as a conductor and can be selectively removed to form specific connection points for circuit board elements.

The present invention provides a method for forming and utilizing a circuit constructed of ETM as a light reflector for the illumination of vehicular features. The ETM circuit is flexible and can be molded to fit any surface of a vehicle, allowing it to be used both on the exterior of a vehicle as well as the interior. The reflective capabilities of an ETM circuit formed with the method of the present invention allow it to reflect light from a low power LED to illuminate nearby features. The method of the present invention also allows the reflective surfaces of the ETM circuit to be formed to provide specific reflectivity characteristics, such as tuned emissivity.

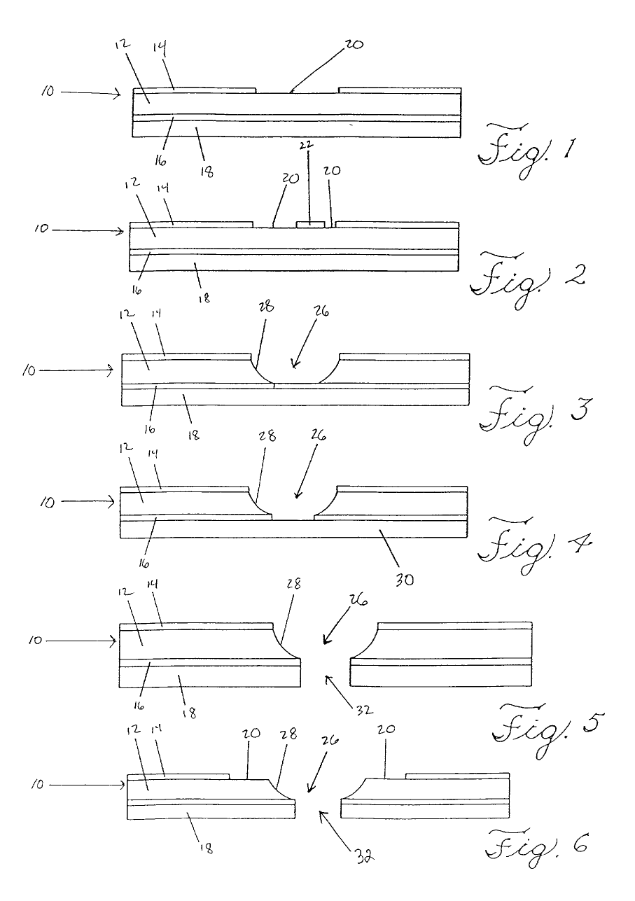

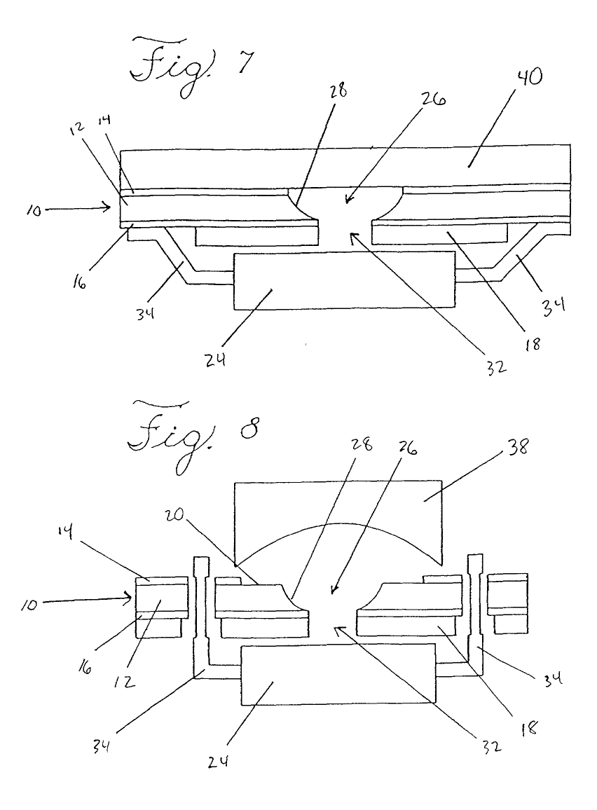

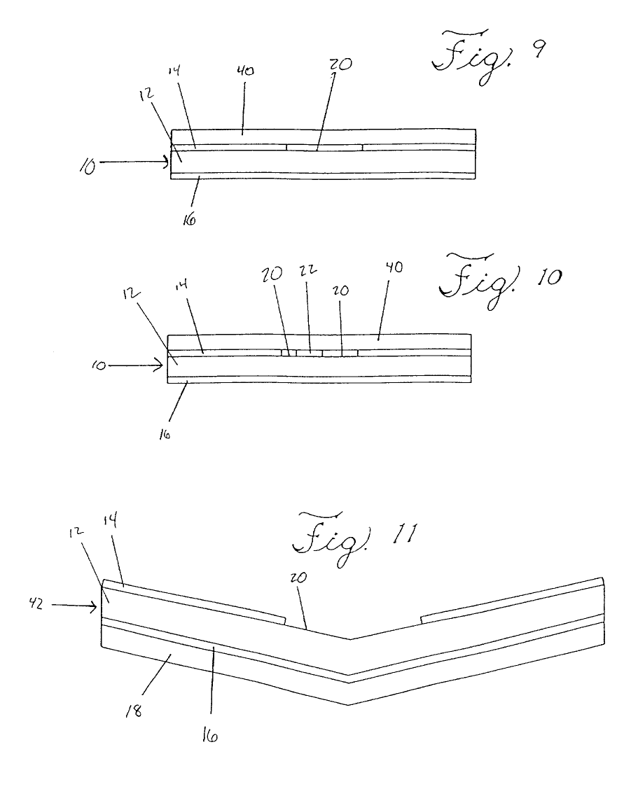

Referring in combination to FIGS. 1 and 2, embodiments of ETM circuits utilizing the present invention are shown. A layered metal substrate 10 is provided preferably formed from at least three layers. An aluminum layer 12 is preferably positioned between a first copper layer 14 and a second copper layer 16. Aluminum and copper are soft metals and allow the substrate 10 to flex to match any surface. The layers of copper 14, 16 are preferably thin, around 0.035-0.15 mm in thickness. In the preferred method, a layer of masking material (not shown) is applied to the copper layer 14 to protect it during the etching process. A standard etching process, as known in the art, is applied to the layered substrate 10 in specific areas to remove portions of the first copper layer 14 that are not covered by the masking layer. The masking material is then removed from the copper layer 14, revealing planar reflective portions 20 of aluminum. As shown in FIG. 2, planar reflective portions 20 may be interrupted with non-reflective portions 22. This configuration may be formed by selective etching of the copper layer 14. The second copper layer 16 may also be etched simultaneously using the same process to produce reflective areas on both sides of the layered metal substrate 10. The planar reflective portions 20 formed as a result of this process are planar. A supporting substrate 18 is preferably positioned on the second copper layer 16. The supporting substrate 18 may be molded to the second copper layer 16 in many ways known in the art, such as by insert molding in an injection-molding or compression molding process, or adhesive attachment. The supporting substrate 18 could be made from any number of materials. Preferably, a localized light source 24 (as shown in FIGS. 7 and 8) is provided to direct light to the reflective portions 20 for illumination. The localized light source 24 is preferably positioned opposite the reflective portions 20.

An alternate embodiment of the present invention allows for the formation of a reflective aperture 26 as shown in FIGS. 3-8. In this embodiment of the method, a layered metal substrate 10 is preferably provided having three layers as described previously. An etching process, as known in the art, is preferably applied to areas of the first copper layer 14 as described in reference to FIGS. 1 and 2. This etching process removes areas of the first copper layer 14. The non-planar areas 28 of the aluminum layer 12 exposed as a result of this process are reflective. The masking material is then washed from the first copper layer 14, and a second masking material is applied to the aluminum layer 12. A supporting substrate 18, as described previously, may then be positioned on the second copper layer 16. A second, aluminum-specific etch process is applied to remove areas of the aluminum layer 12 that are not covered with the masking material or by remaining copper. After etching, the second masking material is washed from the aluminum. It is possible to selectively remove aluminum in this manner to leave non-planar areas that are tuned to certain levels of emissivity and reflectivity levels, depending on the needs of the application. After the etching steps, a localized light source 24 is positioned so as to allow light to reflect off of the non-planar reflective portions 28 formed by the etching process.

A reflective substrate 30 may also be utilized to further adjust the reflective characteristics of the ETM circuit. The reflective substrate 30 is preferably positioned on the second copper layer 16, as shown in FIG. 5.

Referring to FIGS. 5-8, it is possible to define an aperture 32 in the supporting substrate 18 to allow positioning of the localized light source 24 behind the supporting substrate 18. The aperture 32 is preferably aligned with a removed area of the second copper layer 16. Referring to FIGS. 6 and 8, it is also possible to combine the methods previously described to form both planar 20 and non-planar reflective portions 28 on the same ETM circuit.

Referring to FIGS. 7 and 8, alternate ways to mount a localized light source 24 are shown. FIG. 7 shows a localized light source 24 mounted by means of supports 34 attached to the second copper layer 16. These supports 34 could also be attached to the supporting substrate 18 or the aluminum layer 12. FIG. 8 shows a mounting structure utilizing through holes 36 in the ETM circuit. Each support 34 is placed within a through hole 36. The through holes 36 could pass through all the layers of the ETM circuit as shown, or through only some of them. FIG. 8 also shows an example of a lens 38 mounted so as to adjust or focus the illumination level from the reflective portions 20, 28 of the ETM circuit.

A further method of adjusting the reflectivity or emissivity of the reflective portions 20, 28 is shown in FIGS. 7, 9 and 10. A layer of transparent substrate 40 is preferably positioned on the first copper layer 14 after the copper etching process. The reflectivity or emissivity of the reflective portions could also be adjusted by covering the reflective portions 20, 28 with coatings such as vacuum-deposited reflective aluminum. This could be accomplished by masking all areas of the assembly not to be coated with the reflective aluminum and then applying a standard vacuum deposition process, as known in the art.

FIG. 11 shows an example of a contoured substrate 42 with planar reflective portions 20 formed utilizing the present method. The ETM circuit can be bent or flexed in any direction in order to match the surface upon which it is mounted. A contoured substrate 42 with non-planar reflective portions 28 could also be formed utilizing the present method.

The present method allows the ETM substrate to function as both a circuit board and as a light reflector. There is no need for extraneous parts such as metal frets and busses. The circuit and reflector are completely self-contained and can flex to match the contours of any surface. This improves efficiency and reduced the cost of production. The instances of short circuiting are also reduced.

It should be noted that there could be a wide range of changes made to the present invention without departing from its scope. Planar and non-planar reflective portions could be combined in one application and could be configured differently than shown in the Figures. The localized light source 24 could be positioned differently, and different types of light sources could be used. It is also possible to position insulating layers of material between the copper layers 14, 16 and the aluminum layer 12, if desired. The extra insulating layer would be removed in a similar manner as the other layers to expose the reflective portions of aluminum. Alternative lenses or other focusing means could be positioned relative to the ETM circuit to redirect the reflected light. Thus, it is intended that the foregoing detailed description be regarded as illustrative rather than limiting and that it be understood that it is the following claims, including all equivalents, which are intended to define the scope of the invention.

What is claimed is:

1. A method for constructing an illuminating and reflecting apparatus, said method comprising the steps of:
providing a layered metal substrate with an aluminum layer positioned between a first and a second copper layer;
removing at least a defined area of said at least one copper layer to form a reflective portion within said area; and
providing a localized light source positioned to allow light to reflect off of said reflective portion.

2. The method of claim 1, further comprising the step of removing an area of said aluminum layer such that a non-planar surface is formed in said aluminum layer.

3. The method of claim 2, further comprising the step of removing a defined area of at least one copper layer such that an opening is defined in said layered metal substrate.

4. The method of claim 3, further comprising the step of coating said reflective portion with a substance to provide specific reflectivity levels.

5. The method of claim 3, further comprising the step of providing a transparent substrate positioned on said first copper layer.

6. The method of claim 3, further comprising the step of providing a reflective substrate positioned on said second copper layer.

7. A method for forming a reflective aperture in a circuit board for providing illumination in automotive applications, said method comprising the steps of:
providing a layered metal substrate;
removing at least a top layer of said layered metal substrate to form a reflective area; and
providing a localized light source positioned so as to allow light to reflect off of said reflective area.

8. The method of claim 7, further comprising the step of defining a non-planar aperture in the middle layer of said layered metal substrate.

9. The method of claim 8, further comprising the step of defining an aperture in the bottom layer of said layered metal substrate aligned with said non-planar aperture in said middle layer.

10. A method for forming a reflective aperture in a circuit board for providing illumination in automotive applications, said method comprising the steps of:
providing a layered metal substrate;
applying a layer of masking material on a surface of at least one layer of said layered metal substrate;
exposing said layered metal substrate to an etching process;
removing said masking material from said at least one layer of said layered metal substrate to expose reflective areas of said aluminum layer; and
providing a localized light source positioned so as to allow light to reflect off of said reflective area.

11. The method of claim 10, further comprising the steps of:
applying a layer of masking material on a surface of said aluminum layer;
exposing said layered metal substrate to an aluminum etching process; and
removing said masking material from said aluminum layer.

12. The method of claim 11, further comprising the step of defining a non-planar aperture in the middle layer of said layered metal substrate.

13. The method of claim 12, further comprising the step of defining an aperture in the bottom layer of said layered metal substrate aligned with said non-planar aperture in said middle layer.

14. A reflective circuit board comprising:
a substrate comprised of a layer of aluminum positioned between two layers of copper;
at least one exposed area of reflective aluminum; and
a localized light source positioned to provide illumination of said exposed aluminum.

15. The reflective circuit board of claim 14, further comprising a non-planar aperture defined in said aluminum layer.

16. The reflective circuit board of claim 15, further comprising an aperture defined through all of said layers of said substrate.

17. The reflective circuit board of claim 15, further comprising a reflective coating on said non-planar surfaces of said aluminum layer.

18. The reflective circuit board of claim 16, wherein said localized light source is substantially aligned with said aperture.

19. The reflective circuit board of claim 18, further comprising a `layer of reflective substrate over said aperture opposite said localized light source.

20. The reflective circuit board of claim 14, further comprising a layer of transparent substrate over said at least one layer of exposed aluminum.
